(19) United States
(12) Patent Application Publication
(10) Pub. No.: US 2017/0357925 A1
(43) Pub. Date: Dec. 14, 2017

(54) Production Plan Making Assistance Apparatus and Production Plan Making Assistance Method

(71) Applicant: Hitachi, Ltd., Tokyo (JP)

(72) Inventors: Masataka TANAKA, Tokyo (JP); Hisaya ISHIBASHI, Tokyo (JP); Toshihiro MORISAWA, Tokyo (JP); Kouichirou HARO, Tokyo (JP); Hiroyuki SEYA, Tokyo (JP)

(21) Appl. No.: 15/616,421

(22) Filed: Jun. 7, 2017

(30) Foreign Application Priority Data
Jun. 10, 2016 (JP) 2016-116469

(51) Int. Cl. G06Q 10/06

(52) U.S. Cl. CPC G06Q 10/06315

(57) ABSTRACT

A production plan making assistance apparatus for a product including a plurality of components, the production plan making assistance apparatus comprising: a storage unit; an input-output unit; and an operation unit; wherein the operation unit reads out the information stored in the storage unit and assigns a start date and a completion date in each process based on a process in which consumption of the production resource lies within the production ability and which synchronizes with the lead time, and wherein the operation unit specifies the completion date assigned to each previous process in a plurality of synchronizing processes, specifies a start date assigned to the process continuing to the specified completion date, calculates a total period between the specified completion date and the specified start date as a total non-synchronization degree and outputs the calculated total non-synchronization degree to the input-output unit.

### CLAIM OF PRIORITY

The present application claims priority from Japanese application JP 2016-116469 filed on Jun. 10, 2016, the content of which is hereby incorporated by reference in this application.

### BACKGROUND OF THE INVENTION

The present invention relates to a production plan making assistance apparatus and a production plan making assistance method.

As Background Art, it is well-known Japanese Patent Application Publication No. 2015-5032. In Japanese Patent Application Publication NO. 2015-5032, it is described “the engineering schedule control device 10a of the embodiment includes a display unit 51, an engineering schedule DB 41, a work input unit 12 receiving an input concerning work plan and work contents, a resource input unit 11 receiving an input concerning resource, a work attribute setting unit 6 for setting work attribute, work context setting unit 7 for setting context between works, a PERT execution unit 21 demanding float every work, a priority order evaluation unit 22 for setting priority order based on work float and predetermined evaluation function, a resource leveling execution unit 23 for assigning resources against a plurality of works, an execution ES control unit 33a for preparing engineering schedule data and registering or renewing the engineering schedule in the engineering schedule DB 41”.

System products such as control panels and the like is constructed from a plurality of control panels and various units and are the special order products each construction of which is designed according to customer's order, produced, tested and forwarded. In factory and each process/production site (area), a plurality of products are simultaneously produced parallel. In the various control panels or units, there are mixed those that production resources necessary to produce such as design post in charge of product's design, production lines and testing facilities according to the kind of products are commonly used and those that such production resources are not commonly used. Therefore, resource competition occurs between each of processes in components of order item.

When resource competition occurs, production of any product becomes the deferment. However, in production of control panel, during the intermediate process such as combining units to the control panel, combination test of plural control panels and the like, it is necessitated synchronization of production between components in each order item (putting together starting date of production).

Also in a case other than control panels, above variations in combination exist in construction of software function or apparatus in system products. Therefore, in order to observe delivery date of all order items, it is necessary to plan production schedule taking synchronization of production within order item into consideration and produce real products while avoiding resource competition between components mentioned above.

Contrarily, production schedule can be planned by utilizing technology disclosed in Japanese Patent Application Publication No. 2015-5032. However, it is not necessarily realized that production lead time can be shortened by utilizing the technology described in Japanese Patent Application Publication No. 2015-5032. Therefore, for example, when units are combined into the control panel, there will occur a problem that only production schedule of units is advanced and units stay as middle work in hand until units are combined. As a result, there will occur a problem that production lead time from customer's order to forwarding is prolonged.

Accordingly, the present invention has an object to provide an apparatus to assist in plan making of production schedule by quantifying non-synchronization degree becoming cause of prolongation of production lead time and indicating it.

### SUMMARY OF THE INVENTION

To dissolve the above problems, the production plan making assistance apparatus according to the present invention is a production plan making assistance apparatus for a product including a plurality of components, the production plan making assistance apparatus comprising: a storage unit for storing information of lead time in each process of a plurality of processes to produce each component, information of the process synchronizing in production of different component and information of production ability of production resource; an input-output unit for displaying a process result; and an operation unit for processing the information stored in the storage unit; wherein the operation unit reads out the information stored in the storage unit and assigns a start date and a completion date in each process based on a process in which consumption of the production resource lies within the production ability and which synchronizes with the lead time, and wherein the operation unit specifies the completion date assigned to each previous process in a plurality of synchronizing processes, specifies a start date assigned to the process continuing to the specified completion date, calculates a total period between the specified completion date and the specified start date as a total non-synchronization degree and outputs the calculated total non-synchronization degree to the input-output unit.

According to one aspect of the present invention, the non-synchronization degree becoming cause of prolongation of production lead time is quantified and indicated, thereby it can be provided an apparatus to assist in plan making of production schedule.

### BRIEF DESCRIPTION OF THE DRAWINGS

FIG. 1 is a figure indicating one example of process flowchart for production schedule making in a first embodiment;

FIG. 2 is a block diagram indicating one example of construction of a production plan making assistance apparatus in the first embodiment;

FIG. 3 is a figure indicating one example of order information;

FIG. 4 is a figure indicating one example of process information;

FIG. 5 is a figure indicating one example of process order information;

FIG. 6 is a figure indicating one example of production ability information;

FIG. 7 is a figure indicating one example of production resource consumption information;

FIG. 8 is a figure indicating one example of production schedule plan information;

FIG. 9 is a figure indicating one example of production load information;

FIG. 10 is a figure indicating one example of non-synchronization degree information in the first embodiment;

FIG. 11 is a figure indicating one example of input screen;

FIG. 12 is a figure indicating one example of the first production schedule plan information and production load information;

FIG. 13 is a figure indicating one example of the second production schedule plan information and production load information;

FIG. 14 is a figure indicating one example of the third production schedule plan information;

FIG. 15 is a figure indicating one example of process flowchart of non-synchronization degree calculation in the first embodiment;

FIG. 16 is a figure indicating one example of the first output screen in the first embodiment;

FIG. 17 is a figure indicating one example of the second output screen in the first embodiment;

FIG. 18 is a figure indicating one example of the third output screen in the first embodiment;

FIG. 19 is a block diagram indicating one example of construction of production plan making assistance apparatus according to the second embodiment;

FIG. 20 is a figure indicating one example of production cost price information;

FIG. 21 is a figure indicating one example of process flowchart of non-synchronization degree calculation in a second embodiment;

FIG. 22 is a figure indicating one example of non-synchronization degree information in the second embodiment.

FIG. 23 is a figure indicating one example of output screen in the second embodiment;

FIG. 24 is a block diagram indicating one example of construction of production plan making assistance apparatus according to a third embodiment;

FIG. 25 is a figure indicating one example of process flowchart of production plan making in the third embodiment;

FIG. 26 is a figure indicating one example of item exchange candidate information;

FIG. 27 is a figure indicating one example of the fourth production schedule plan information;

FIG. 28 is a figure indicating one example of non-synchronization degree information in the third embodiment;

FIG. 29 is a figure indicating one example of the first output screen in the third embodiment; and

FIG. 30 is a figure indicating one example of the second output screen in the third embodiment.

### DETAILED DESCRIPTION OF THE PREFERRED EMBODIMENTS

Hereinafter, the embodiments of the present invention will be described with reference to the drawings.

### First Embodiment

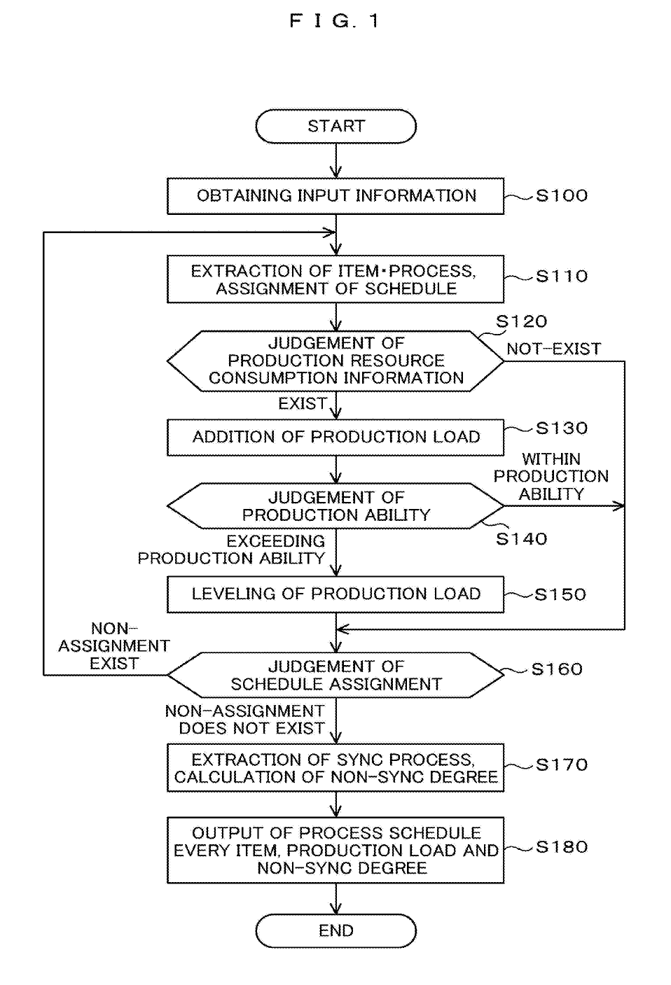

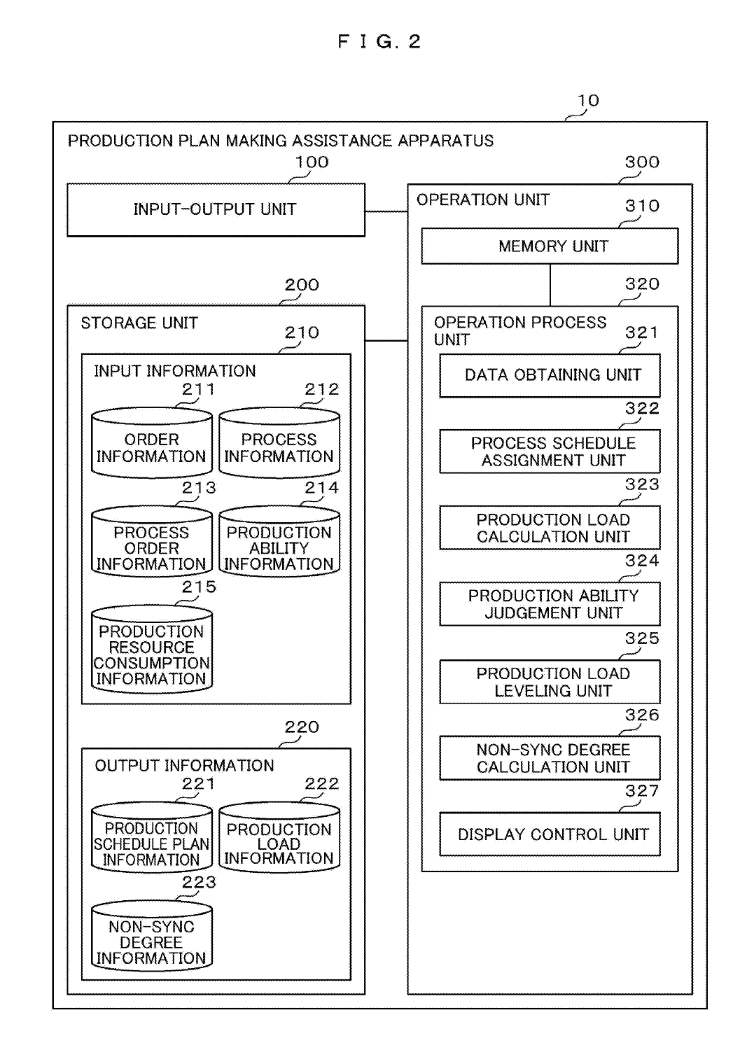

FIG. 1 indicates one example of process flowchart in the present embodiment and FIG. 2 is a block diagram indicating one example of construction of a production plan making assistance apparatus 10 according to the present embodiment. In FIG. 2, the production plan making assistance apparatus 10 is an apparatus including PC (computer) such as server or terminal and the like and software installed in the PC. The production plan making assistance apparatus 10 includes an input-output unit 100, a storage unit 200 and an operation unit 300.

The input-output unit 100 is a unit to obtain data necessary for process of the operation unit 300 and to display process result. For example, this input-output unit 100 is constructed so as to include an input device such as keyboard or mouse, a communication device to communicate with the outside, a record-playback device such as disc-type storing medium and an output device such as CRT or liquid crystal monitor.

The storage unit 200 includes input information 210 utilized in process of the operation unit 300 and output information 220 storing process result and is constructed from a memory device such as hard disc drive, solid-state drive, memory and the like. The input information 210 includes order information 211, process information 212, process order information 213, production ability information 214 and production resource consumption information 215. These kinds of information will be described hereinafter.

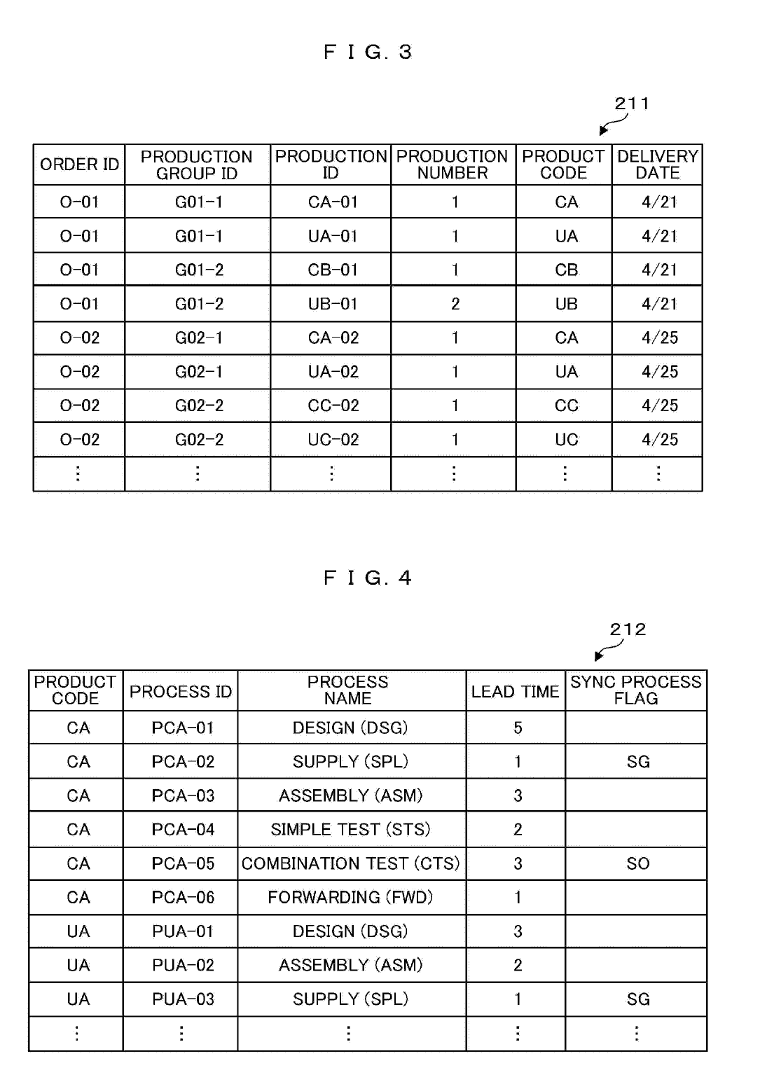

The order information 211 is information to control products concerning orders from customers and delivery data thereof. For example, as shown in FIG. 3, the order information 211 includes information of order ID, production group ID, production ID, production number, product code, delivery date. In the order information 211 shown in FIG. 3, for example, the order item of order ID “O-01” indicates that it is accepted an order: products (kinds of products) with product code “CA”, “UA”, “CB”, “UB” are respectively accepted by “1 (product)” with production ID “CA-01”, “1 (product)” with production ID “UA-01”, “1 (product)” with production ID “CB-01”, “2 (products)” with production ID “UB-01” and delivery date of “4/21”.

Further, it is shown: products with production ID “CA-01”, “UA-01” will be produced in production group ID “G01-1”, products with production ID “CB-01”, “UB-01” will be produced in production group ID “G01-2”. For example, when one product is constructed from more than one housing, one production group is assigned to one housing. Here, production group is not limited to this, and more than one production group may be assigned to one product based on any standard.

Here, when the order information 211 is represented as in FIG. 3, one line in the table is called as record and combination of “O-01”, “G01-1”, “CA-01”, “1”, “CA” and “4/21” is called as the first record item and combination of “O-01”, “G01-1”, “UA-01”, “1”, “UA”, “4/21” is called as the second record item. As for representation in the other table described hereinafter, the line in the table is called as record.

The process information 212 is information to control processes every kind of products and lead time in each of processes. For example, as shown in FIG. 4, the process information 212 includes information of product code, process ID, process name, lead time, and synchronization process flag. In the process information 212 shown in FIG. 4, products with product code “CA” are produced by six processes of “design” (DSG), “supply” (SPL), “assembly” (ASM), “simple test” (STS), “combination test” (CTS), “forwarding” (FWD) and it is indicated that each lead time is “5 (days)”, “1 (day)”, “3 (days)”, “2 (days)”, “3 (days)”, “1 (day)”.

Further, “SG”, “SO” is set as the synchronization process flag of “supply”, “combination test” process. Here, “SG” indicates that start date of the process is synchronized within the same production group ID and “SO” indicates that start date of the process is synchronized within the same order ID. Further, to the synchronized process, the same synchronization process flag is set.

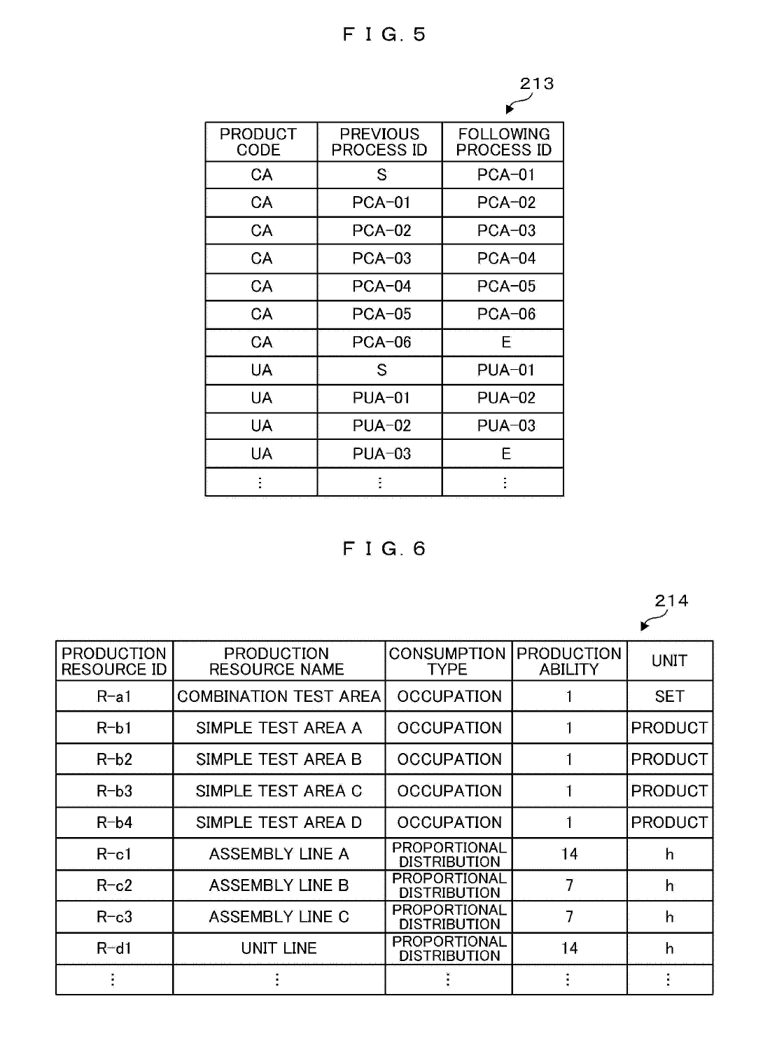

The process order information 213 is information to control process order of each kind of product. For example, as shown in FIG. 5, the process order information 213 includes information of product code, previous process ID and following process ID. In the process order information 213 shown in FIG. 5, production is started from the following process ID in which “S” is set to the previous process ID, next following process is searched by tracing the previous process ID having the above following process and trace is finally conducted to the record in which “E” is set to the following process ID, thereby a series of process order is controlled.

For example, the product with the product code “CA” is started to produce from the following process ID “PCA-01 (design)”to the previous process ID of which is set “S”. Thereafter, passing through processes of “PCA-02 (supply)”, “PCA-03 (assembly)”, “PCA-04 (simple test)”, “PCA-05 (combination test)”, production of the product with the product code “CA” is ended at process of “PCA-06 (forwarding)”.

The production ability information 214 is information to control production resource necessary in each process and includes information of production resource ID, production resource name, consumption type, production ability and unit. In the production ability information 214 shown in FIG. 6, for example, it is indicated that the resource controlled by production resource ID “R-a1” is “combination test area “and production ability is “1 (set)”. In the present embodiment, although production ability is described per one day, production ability may be controlled by time standard necessary for production plan such as per one hour.

Here, the resource controlled by production resource ID “R-c1” is “assembly line A” and “14(n)” of production ability indicates the operable time per one day. Further, “consumption type” is information to direct consumption method of each production resource and “occupation” indicates that production load value in some process is continued to consume over lead time. “Proportional distribution” means that production load value is divided by period of lead time and is assigned to each schedule.

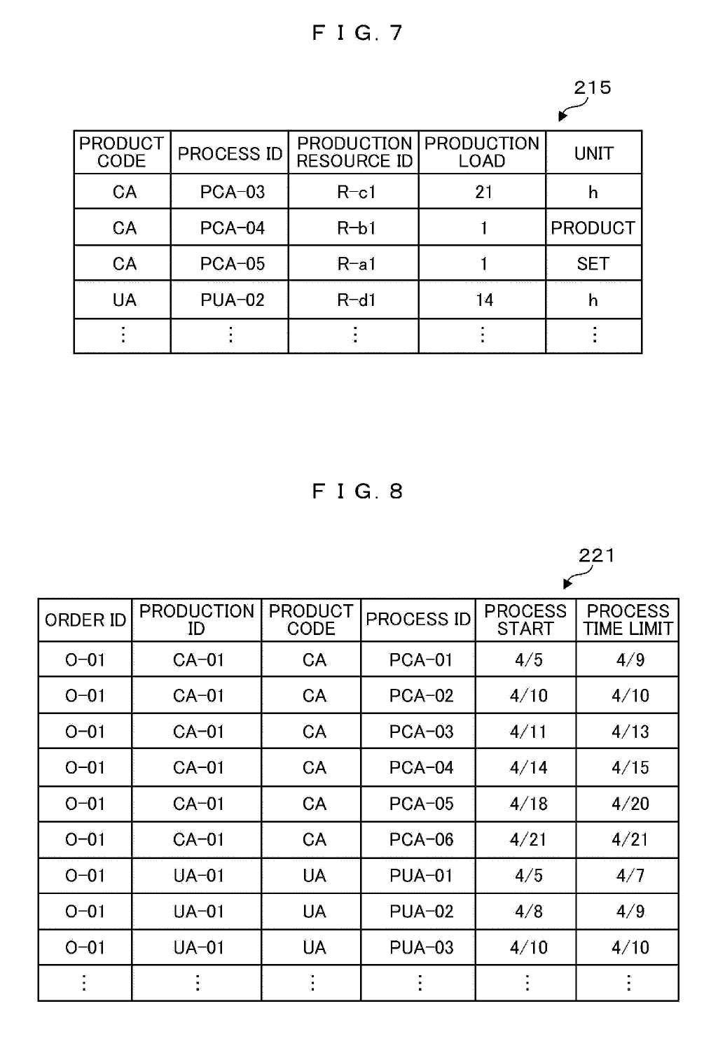

The production resource consumption information 215 is information to control consumption of resource in some product and in some process and includes information of product ID, process ID, production resource ID, production load and unit. In the production resource consumption information 215 shown in FIG. 7, for example, it is indicated in product code “CA”, “process ID “PCA-03” that operation time “21 (h)” is necessitated in the production resource ID “R-c1 (assembly line A)”. In the present embodiment, one production resource is set to one product and one process. Therefore, the operation time “21 (h)” is time per one product and per one process.

However, it is not limited to the above and it may be set for one product and one process a plurality of production resources such as operation time by person or operation time by facilities, operation area and the like. Here, in the product code “CA”, process ID “PCA-05”, it is indicated that production load per one day is “1 (set)” in production resource ID “R-a1 (combination test area)”.

Further, the output information 220 includes production schedule plan information 221, production load information 222 and non-synchronization degree information 223. Each information will be described hereinafter.

The production schedule plan information 221 is information to control completion time limit of process in each component of product or unit and includes order ID, production ID, product code, process ID, process start and process time limit. In the production schedule plan information 221 shown in FIG. 8, for example, it is indicated that order ID “O-01”, production ID “CA-01”, process ID “PCA-01” indicate the plan in which production is started from “4/5” and completed in “4/9”.

The production load information 222 is information to control how each production resource is consumed every day when products are produced corresponding to time limit of each process instructed by the production schedule plan information 221. The production load information 222 includes information of production resource ID, date, order ID, production ID, process ID, production load and unit. In the production load information 222 shown in FIG. 9, for example, it is indicated in production resource ID “R-a1” that operation of order ID “O-01”, production ID “CA-01”, process ID “PCA-05” is executed for “1 (set) over 3 days from “4/18” to “4/20”.

The non-synchronization degree information 223 is information to control collection degree of each component in the process that production synchronization of a plurality of control panels or units and the like is necessary. The non-synchronization information 223 includes information of synchronization ID, order ID, production ID, process ID, non-synchronization degree and total non-synchronization degree. Here, the non-synchronization degree is an index indicating estrangement between the process in which production synchronization of products or units is necessary and the previous process of day unit. Here, it is indicated that the production synchronization is obtained so long as the value thereof is smaller.

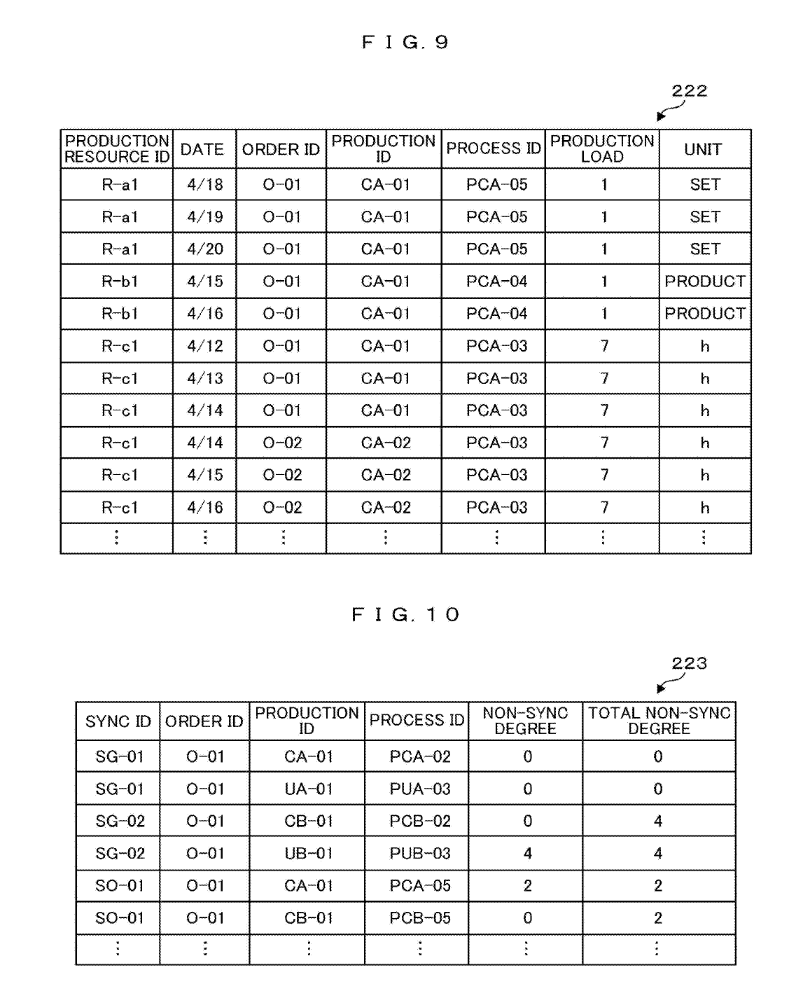

In the non-synchronization degree information 223 shown in FIG. 10, for example, it is indicated in synchronization ID “SG-02”, order ID “O-01” that the non-synchronization degree of process ID “PCB-02” in production ID “CB-01” and process ID “PUB-03” in production ID “UB-01” are respectively “0” and “4”, therefore it is indicated that total of non-synchronization degree in the same synchronization ID is “4”.

Further, returning to FIG. 2, the operation unit 300 is provided to obtain data necessary for operation from the input information 210 of the input-output unit 100 or storage unit 200 and to output process result to the output information 220 of storage unit 200. The operation unit 300 is constructed from operation process unit 320 actually conducting operation process and memory unit 310 which becomes work area of operation process in the operation process unit 320.

The memory unit 310 is provided to temporarily store data obtained from the input information 210 of the input-output unit 100 and storage unit 200 or result processes by the operation process unit 320. The operation process unit 320 includes data obtaining unit 321 for obtaining data necessary for operation from the input information 210 and store in the memory unit 310 and process schedule assignment unit 322 for assigning schedule in each process based on the information of delivery date or process order of each product, process lead time.

Further, the operation process unit 320 includes production load calculation unit 323 for calculating production load every day from information of schedule of each process and production resource consumption, production ability judgment unit 324 for judging whether or not production load for each day exceeds the production ability and production load leveling unit 325 for changing assignment schedule of production load in a case that production load exceeds production ability.

Further, the operation process unit 320 includes non-synchronization degree calculation unit 326 for calculating the non-synchronization degree of production based on a period between start date of the process and time limit of the previous process in the process in which it is necessary to take synchronization of production per order unit or production unit and display control unit 327 for respectively storing information of process time limit every product, process, information production load and ability, calculation result of the non-synchronization degree into the production schedule plan information 221, production load information 222 and non-synchronization degree information 223 and display on the input-output unit 100.

It will be conceivable that the operation process unit 320 is a processor having memory circuit and each unit may be realized based on that program corresponding to each unit is stored in the memory circuit and the processor executes the stored programs. Further, it will be conceivable that the operation process unit 320 is a processor and program corresponding to each unit is stored in the storage unit 200 or memory unit 310 and the operation process unit 320 may operate as each unit based on that the processor executes the stored programs.

Next, according to the process flowchart shown in FIG. 1, example of operation of each function (each unit) in the production plan making assistance apparatus 10 of FIG. 2 will be described.

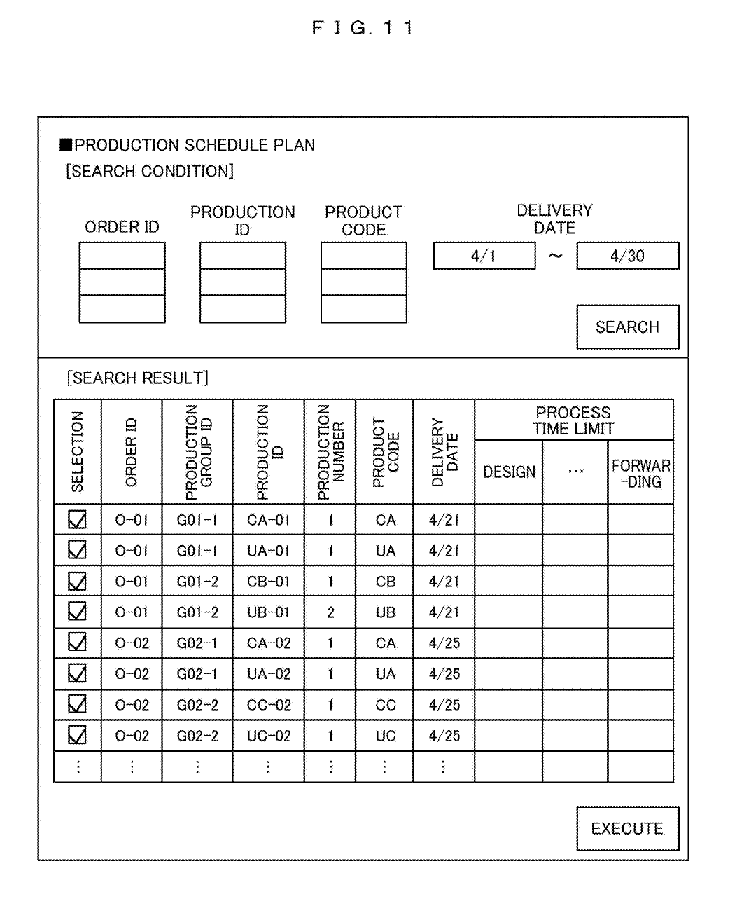

First, for example, the user who is a production manager inputs conditions such as order ID, production ID, product code, time limit becoming plan objects of production schedule in search condition columns on the screen of production schedule plan system shown in FIG. 11 and clicks. Thereby, the order information 211 corresponding to the order item is output and displayed on the search result columns.

Next, the user selects the order item becoming the plan object among the order items output on the search result columns and clicks the execution button. Thereby, process of the production plan making assistance apparatus 10 can be started. Here, the order information 211 and selection information may be received by the input-output unit 100. In the present embodiment, description will be done hereinafter as the order ID “O-01”, “O-02” displayed on the search result columns of FIG. 11 are selected.

The production plan making assistance apparatus 10 starts processes. Thereby, the data obtaining unit 321 obtains the order information 211 selected by the user and obtains the process information 212, the process order information 213, the production ability information 214, the production resource consumption information 215 concerning the order information (S100). On the screen of the production schedule plan system shown in FIG. 11, for example, the information of 1 to 6 record items of the process information 212 shown in FIG. 4 is obtained corresponding to the product code “CA” of the order ID “O-01” and further the information of 1 to 7 record items of the process order information 213 shown in FIG. 5 is obtained.

Furthermore, corresponding to the process ID “PCA-01” to “PCA-06” of the process information 212 shown in FIG. 4, the record items 1 to 3 of the production resource consumption information 215 shown in FIG. 7 are obtained and the record items 1, 2 and 6 of the production ability information 214 shown in FIG. 6 are obtained corresponding to the production resource ID “R-a1”, “R-b1”, “R-c1” of the production resource consumption information 215. Here, description will be continued hereinafter as various kinds of input information are obtained, as shown in FIGS. 3 to 7.

The process schedule assignment unit 322 conducts schedule assignment every product and process based on the time limit of order information 211, the process order every product code in the process order information 213, the lead time every process of the process information 212 (S110). In the present embodiment, it will be described the example in which the production schedule is planned according to the order of order items that the delivery date is set to the far-off date.

In the order information 211 shown in FIG. 3, the delivery dates of two order items “O-01”, “O-02” are respectively set to “4/21”, “4/25” and the delivery date of “O-02” is far-off than the “O-01”. Therefore, schedule assignment every process is conducted from the product (production ID “CA-02”, “UA-02”) of the order item. Here, when the synchronization process flag is set, the schedule assignment may be conducted so that the synchronized process is made the standard.

Next, the process schedule assignment unit 322 obtains the final process “PCA-06” (previous process ID of record in which “E” is set to the following process ID) in the product code “CA” of production ID “CA-02”. Further, the lead time “1 (day)” of the product code “CA”, process ID “PCA-06 (forwarding)” is obtained and the lead time is assigned to “4/25” which is the delivery data of product.

Thereafter, the production load calculation unit 323 judges whether or not the production resource consumption information 215 exists against the process in which assignment is conducted in the process schedule assignment unit 322 (S120). When judged that the production resource consumption information exists, procedure shifts to S130, and on the contrary, when judged that the production resource consumption information does not exist, procedure shifts to S160. In the production resource consumption information 215 shown in FIG. 7, since data does not exist for the product code “CA”, the process ID “PCA-06”, procedure shifts to process of S160.

Next, the process schedule assignment unit 322 judges whether or not process schedule assignment of the order items and process becoming plan object of the production schedule is conducted. When judged that the order items and process not assigned exist, procedure returns to S110 and when judged that the order items and process not assigned does not exist and when schedule assignment in all order items, process is completed, procedure shifts to S170. Here, procedure returns to S110 since assignment is not conducted in the order item “O-02” and process ID “PCA-01” to “PCA-05”.

Similar to the above, the process schedule assignment unit 322 obtains the product code “CA” and lead time “3 (days)” of the previous process “PCA-05 (combination test)” of “PCA-06” (forwarding) and the present process from the process order information 213 shown in FIG. 5 and the process information 212 shown in FIG. 4. The process schedule assignment unit 322 assigns “combination test” process for three days (4/22 to 4/24) from 4/24 which is one day before 4/25 to which “forwarding” process is assigned.

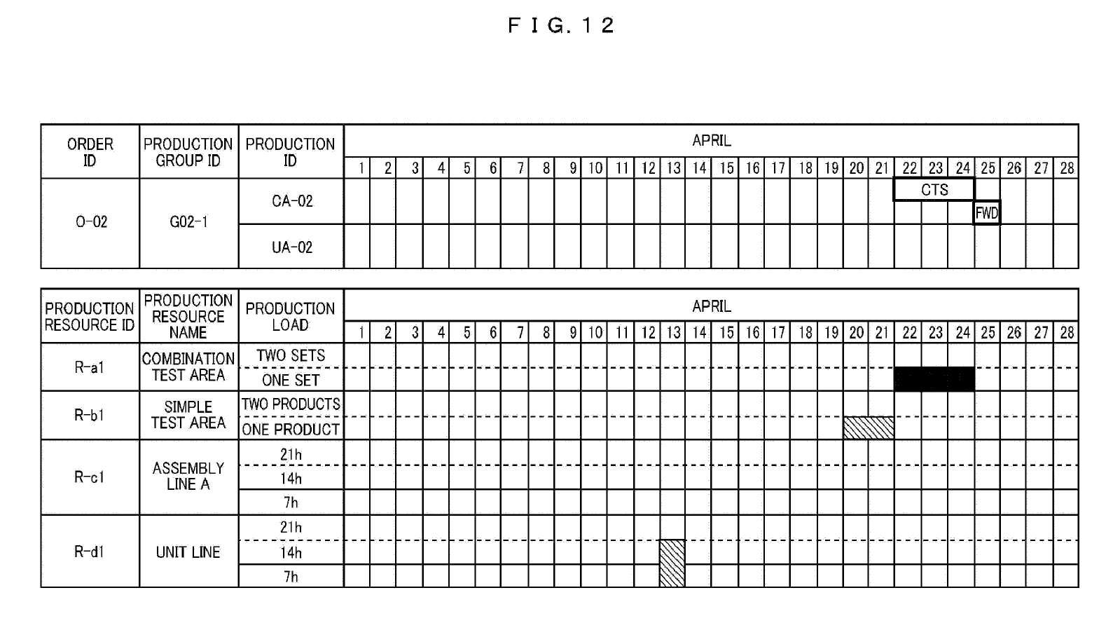

Thereafter, since the production load information of the product code “CA”, process ID “PCA-05” exists (third record item) in the production resource consumption information 215 shown in FIG. 7, the production load calculation unit 323 conducts addition of production load for the process in which schedule assignment is done in S110 (S130). Addition method of production load against the present product, process will be described by using an example of FIG. 12.

The figure (schedule for order ID and the like) described at the upper side in FIG. 12 is information of production schedule plan in which schedule is assigned every product, process. It is indicated that the schedule in each process is assigned by the period surrounded by the bold line frame. Further, the figure (schedule for production resource ID and the like) described at the lower side in FIG. 12 is information of production ability for each production resource and production load addition. It is indicated that the bold dot line indicates ability of each production resource, the black cell indicates load added thereto, gray cell indicates load already added in the other order item.

First, the production load calculation unit 323 obtains the production resource ID “R-a1” (combination test area)“, the production load “1 (set)” of the product code “CA”, the process ID “PCA-05” from the production resource consumption information 215 shown in FIG. 7 and obtains the production number “1” of the production ID “CA-02” from the order information 211 shown in FIG. 3 and integrates. Next, the production load calculation unit 323 obtains the consumption type “occupation” and production ability “1 (set)” of the production resource and respectively adds “1 (set)” during 3 days of 4/22 to 4/24 to which the process is assigned (see black cells of FIG. 12).

Further, the production ability judgement unit 324 judges whether or not the load every the production resource added by the production load calculation unit 323 exceeds the production ability in each resource (S140). When judged that the load exceeds the production ability, procedure shifts to S150 and when judged that the load lies within the production ability, procedure shifts to S160.

For the production schedule of the production ID “CA-02”, the process ID “PCA-05 (combination test)” shown in FIG. 12, since the production load of the production resource “R-a1 (combination test)” lies within the ability (1 set), procedure shifts to S160. Here, since the process ID “PCA-01” to “PCA-04” of the order item “O-02” and the production ID “CA-02” are not assigned, procedure returns to S110 (S160).

Next, similar to the above, the process schedule assignment unit 322 obtains the lead time “2 (days)” of the previous process “PCA-04 (simple test)” and the present process of the product code “CA”, “PCA-05 (combination test)” from the process order information 213 shown in FIG. 5 and the process information 212 shown in FIG. 4 and assigns “simple test” process during 2 days (4/21 to 4/22) from 4/21 which is one day before the start date of “4/21 to 4/24” to which “combination test” process is assigned.

The production load calculation unit 323, similar to the process in S130, obtains the production resource ID “R-b (simple test area)”, the production load “1 (product)” of the present process from the production resource consumption information 215 shown in FIG. 7 and obtains the production number “1” of the production ID “CA-02” from the order information 211 shown in FIG. 3, thereafter integrates. Further, the production load calculation unit 323 obtains the resource consumption type “occupation” and the production ability “1 (product)” from the order information 211 shown in FIG. 3 and respectively adds “1 (product)” during 2 days of 4/21 to 4/22 to which the present process is assigned.

Thereafter, the production ability judgement unit 324, similar to the process in S140, compares the production ability of resource with the load. In the simple test area A shown in FIG. 12, the production load of the other item is already added during 4/20 to 4/21 (see gray cells in FIG. 12) and the production load exceeds the production ability, procedure shifts to S150.

The production load leveling unit 325 shifts the present process to the day that the production load lies within the ability (S150). In the “simple test area A” shown in FIG. 12, the production load lies within the ability by moving up the schedule to 4/18 to 4/19, thereby “simple test” is assigned to this date.

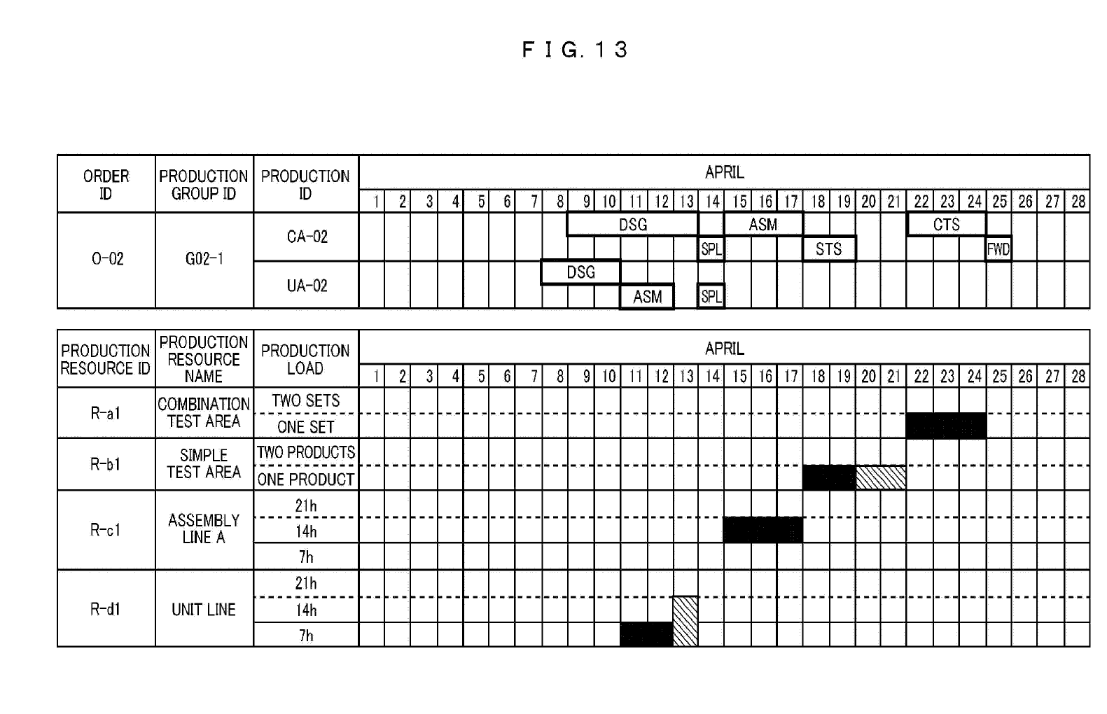

Processes of S110 to S160 described in the above are carried out for the production ID “CA-02”, “UA-02” of the order ID “O-02”, thereby information of the production schedule plan and the production load shown in FIG. 13 is made. In the upper figure of FIG. 13, although supply date of the production ID “CA-02”, “UA-02” are gathered to “4/14”, this is due to the synchronization process flag “SG” of the process ID “PCA-02 (supply)” in the process information 212 of FIG. 4.

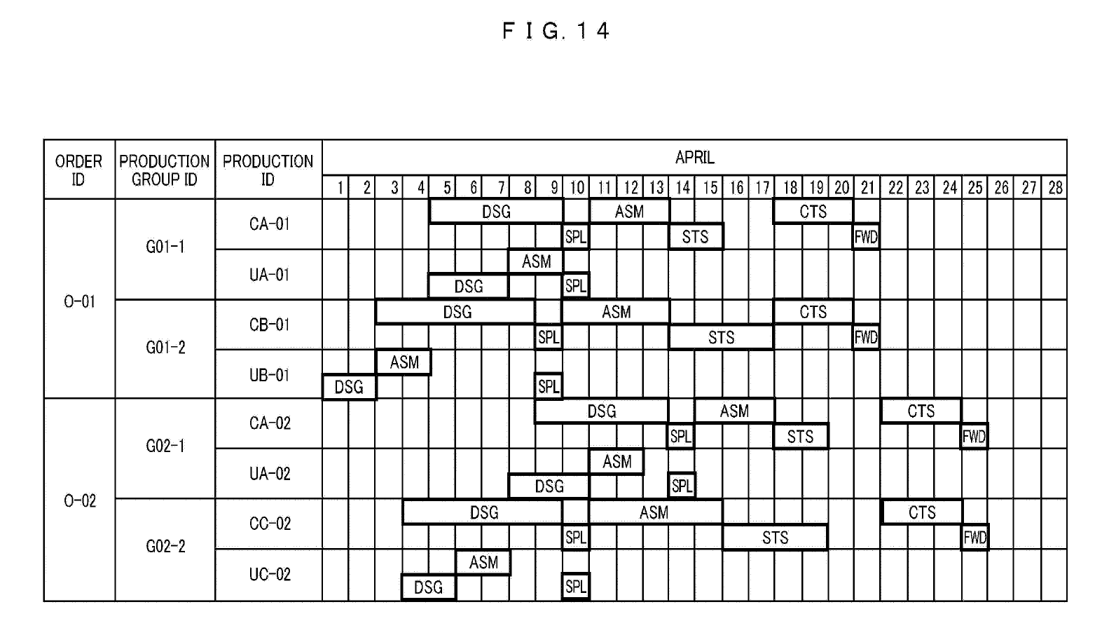

The synchronization flag indicates that the start date of the present process is synchronized with the production ID unit. In the order information 211 shown in FIG. 3, since the production group of “production ID “CA-02”, “UA-02” coincides with “G02-1”, supply is assigned to the same day. Further, supposed that the similar processes are carried out for the order ID “O-01”, the production schedule plan shown in FIG. 14 is made and the production schedule plan information 221 shown in FIG. 8 and the production load information 222 shown in FIG. 9 are made, description will be done hereinafter.

Thereafter, the non-synchronization degree calculation unit 326 calculates the non-synchronization degree in each process based on the production schedule plan information 221 and information of the synchronization process flag in the process information 212 (S170). The non-synchronization degree is an index representing stay degree of production between the present process and the previous process in the process necessary for production synchronization among a plurality of components. The non-synchronization degree is, for example, calculated as the total of period between the start date of the present process and the completion date of the previous process.

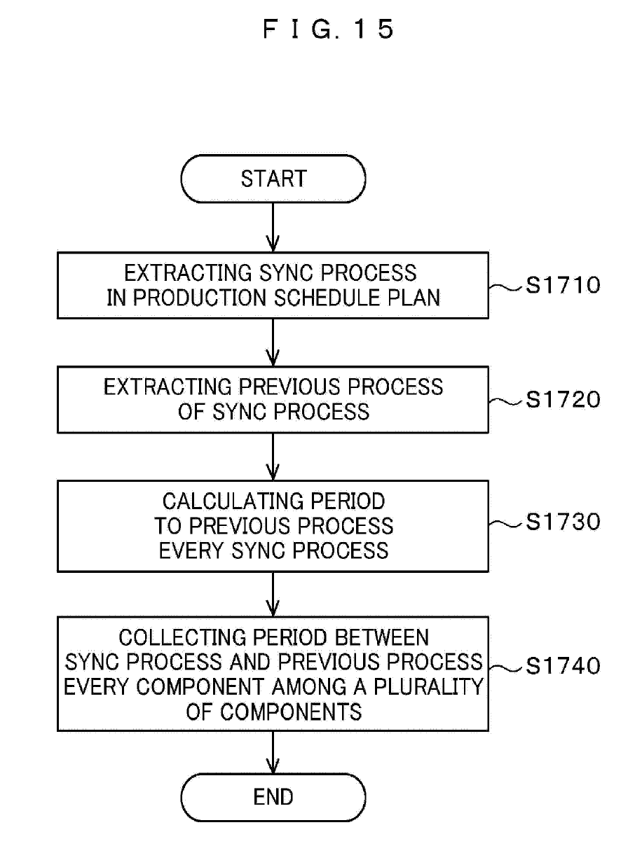

In the present embodiment, while making the example of the production schedule plan shown in FIG. 14 as the object, an example of calculation process of the non-synchronization degree will be described referring to the flowchart shown in FIG. 15. First, the non-synchronization degree calculation unit 326 extracts the synchronization process along the plan for each product in the production schedule plan information 221 (S1710).

Concretely, the non-synchronization degree calculation unit 326 extracts the process ID of the process information 212 and the synchronization process flag from the product code of the production schedule plan information 221. In the production schedule plan information shown in FIG. 14, for example, the synchronization process of the production ID “CA-01” is “PCA-02 (supply)” and “PCA-05 (combination test)” form the process information 212 shown in FIG. 4 and obtains the synchronization process flag “SG”, “SO” for these processes.

Next, the non-synchronization degree calculation unit 326 obtains the previous processes for the above synchronization processes from the process order information 213 (S1720). In the process order information 213 shown in FIG. 5, the previous processes of “PCA-02” and “PCA-05” are respectively “PCA-01” and “PCA-04”. Such information is obtained.

Further, the total of period to the previous process every synchronization process extracted in S1710 is calculated (S1730).

For example, in the information of the production schedule plan shown in FIG. 14, the start date of “PCA-05 (combination test)” which is the synchronization process of the production ID “CA-01” is specified and the process time limit (completion date) of “PCA-04 (simple test)” which is the previous process is specified. Further, it is calculated that the period of “2 (days)” exists from the process time limit of “PCA-04 (simple test)” which is the previous process against the start date of “PCA-05 (combination test)”.

Further, the start date of “PCB-05 (combination test)” which is the synchronization process of the production ID “CB-01” is specified and the process time limit (completion date) of “PCB-04 (simple test)” which is the previous process is specified. Furthermore, it is calculated that the period of “0 (day)” exists from the process time limit of “PCB-04 (simple test)” which is the previous process against the start date of “PCB-05 (combination test)”. “2 (days)” and “0 (day)” are totaled, thereby “2 (days)” is calculated.

Thereafter, the non-synchronization degree calculation unit 326 collects the period of the synchronization process and the previous process calculated in S1730 every component of the product (S1740). In the present embodiment, supposed that the non-synchronization degree information 223 shown in FIG. 10 is produced from the non-synchronization degree every product calculated in the process of S1730, description will be done hereafter.

Returning to the flowchart in FIG. 1, the display control unit 327 respectively stores the production schedule plan every order item stored in the memory unit 310, the production load for the production resource every date, the information of the non-synchronization degree calculated in the above into the production schedule plan information 221, the production load information 222 and the non-synchronization degree information 223 and displays on the input-output unit 100 (S180).

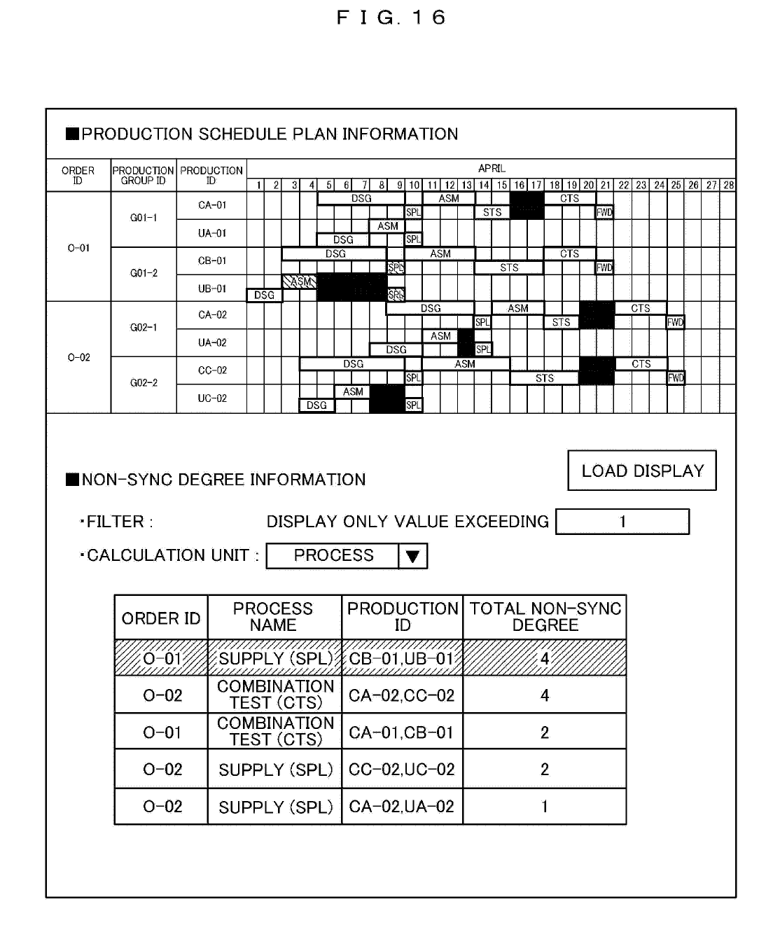

An example of output screen in the present embodiment is shown in FIG. 16. At the upper side of the screen, the order items and the process table every component are displayed based on the production schedule plan information 221. Further, on that screen, the non-synchronization period in the synchronization process is displayed by black color based on the non-synchronization degree information 223, thereby points where production synchronization is not taken can be confirmed in the process table.

Furthermore, at the lower side of the screen calculation result of total non-synchronization degree in each synchronization process is displayed. In the table, the result is sorted according to the order in which the total non-synchronization degree becomes larger, thereby filtering corresponding to the value of the total non-synchronization degree is conducted. Further, as shown in the output screen of FIG. 16, when the record in the table is selected, item concerning in the process table, process (order ID “O-01”, process name “supply”) are highlighted, thereby points of process improvement corresponding to the total non-synchronization degree can be confirmed.

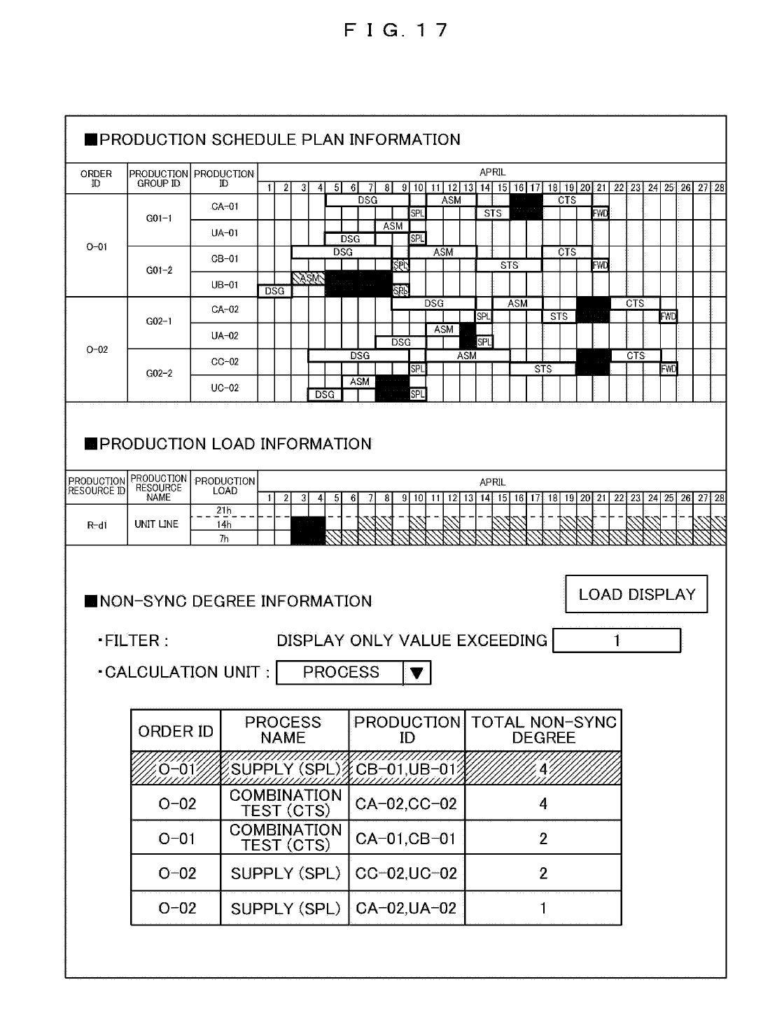

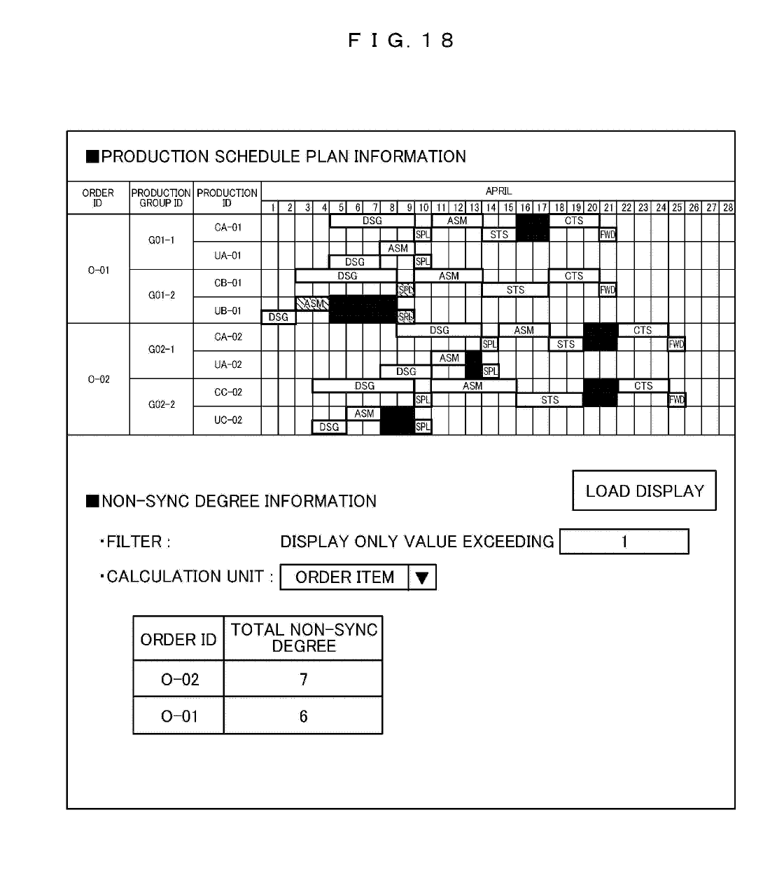

Further, in the present screen, when the “load display” button is clicked under the state that the record of table is selected, information of the production resource and the production load concerning the process of record is displayed as the output screen shown in FIG. 17. In FIG. 17, it is indicated a state after the first record item of the non-synchronization degree information is selected and “load display” button is clicked. In the present screen, it is displayed an example under the state that the production resource “R-d1 (unit line)” is assigned to the previous process “PUB-02 (assembly)” of the production ID “UB-01”. The assembly date of the present production is 2 days of “4/3 to 4/4 and is highlighted in the production load information column of the present screen by black cells.

Further, in the production load information column, the adding state of production load in the schedule before and after the production resource is displayed by gray cells, thereby examination for reduction of middle work in hand, such as whether or not the schedule can be shifted to later date by shortening the lead time and corresponding to over-time work, can be done.

As described in the above, the intermediate process in which production does not synchronize can be quantitatively displayed for the order item constructed from a plurality of products or units. Further, based on this display, the user can grasp middle work in hand, thereby it can be made the production schedule plan to effectively reduce middle work in hand in whole factory.

Here, in the present embodiment, although total non-synchronization degree is calculated every process in S1730 and the calculated result is displayed, the non-synchronization degree may be collected every order item in S1740 and the collected result may be displayed.

Instead of the output screen shown in FIG. 16, it is shown in FIG. 18 an example of output screen in which the total non-synchronization degree is collected every order item and the collected result is displayed.

Based on that the user sees this display, the object of production schedule plan becomes more, and even if schedule preparation of individual schedule is difficult, review of the production schedule plan can be conducted in a wide viewpoint such as shortening of production lead time, review of production line or outsourcing of order items.

### Second Embodiment

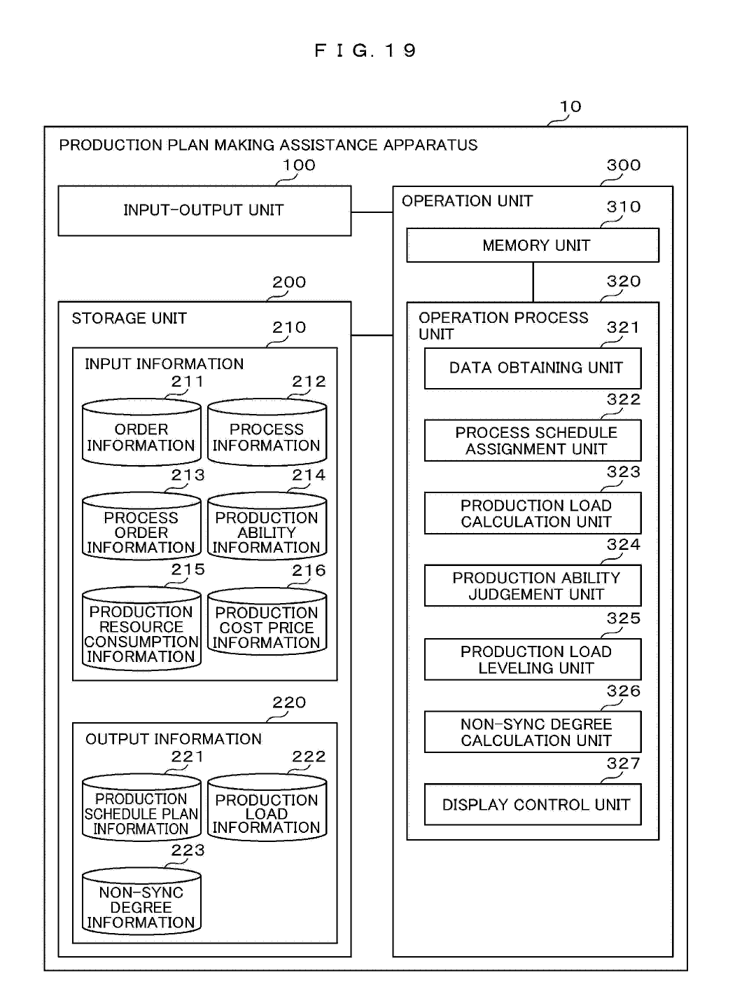

As a second embodiment, when the non-synchronization degree of production is calculated in a plurality of components, it will further indicate an example that production cost price of each component will be integrated and appreciated. The production plan making assistance apparatus 10 of the present embodiment, as shown in FIG. 19, is constructed by adding a production cost price information 216 to the input information 210 of the storage unit 200 in the construction of the production schedule plan making apparatus 10 shown in FIG. 2.

Further, process of the present embodiment will be described by using the flowchart shown in FIG. 1. Here, as for the processes as same as those in the first embodiment, description will be omitted. However, since operation of the non-synchronization degree calculation unit 326 in FIG. 19 is different from the operation in FIG. 2, process contents in S170 is different. Therefore, such process contents will be described by using FIG. 21.

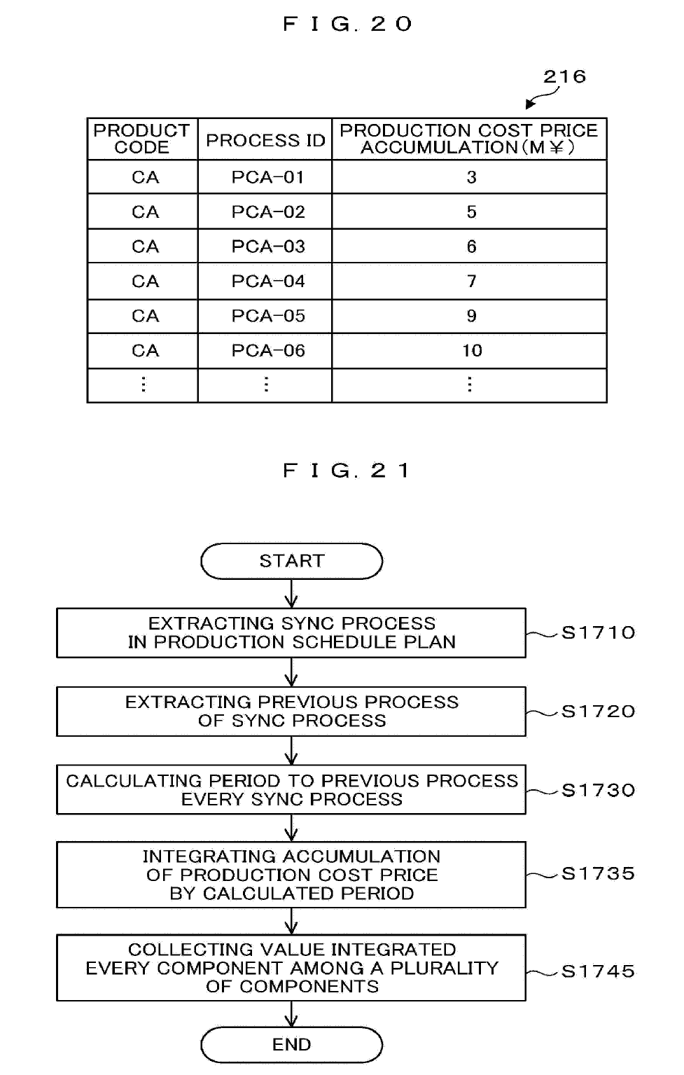

The production cost price information 216 is the information to control the production cost price necessary up to each process every kind of product and includes the product code, the process ID and the information of accumulated product cost price. In the product cost price information 216 shown in FIG. 20, it is indicated that the production cost price taken until the process ID “PCA-01 (design)” of the product code “CA” is completed is “3 (MY)”.

Further, the information of accumulated production cost price indicates accumulation from the first process and it is indicated that the production cost price of “10 (M¥)” is taken until the process ID “PCA-06 (forwarding)” being the final process from the first process of the product code.

Next, operation in the production plan making assistance apparatus 10 of FIG. 19 will be described according to the flowchart shown in FIG. 1. First, the data obtaining unit 321 obtains the production cost price information 216 in addition to the order information 211, the process information 212, the process order information 213, the production ability information 214 and the production resource consumption information 215 (S100). Here, supposed that various kinds of information shown in FIGS. 3 to 7 and FIG. 20 are obtained, description will be done hereinafter.

Here, description of the processes of S110 to S160 will be omitted since such processes are as same as those in the first embodiment. Supposed that the production schedule plan shown in FIG. 14, the production schedule plan information 221 shown in FIG. 8 and the production load information 222 shown in FIG. 9 are produced, description will be done hereinafter.

The non-synchronization degree calculation unit 326 calculates the non-synchronization degree in each process based on the production schedule plan information 221 and the synchronization process flag information in the process information 212 (S170). In the present embodiment, by making an example of the production schedule plan shown in FIG. 14 as the object, the non-synchronization degree calculation process will be described by using the flowchart shown in FIG. 21. Here, since processes in S1710 to S1730 are as same as those in the first embodiment, description thereof will be omitted.

The non-synchronization degree calculation unit 326 integrates the production cost price necessitated up to the previous process during the period to the previous process every the synchronization process (S1735). For example, in the production schedule plan shown in FIG. 14, the start date of the synchronization process “PCA-05 (combination test)”of the production ID “CA-01” is specified and the completion date of the previous process “PCA-04” (simple test)” is specified, thus the period between “PCA-05 (combination test)” and the previous process “PCA-04 (simple test)” is “2 (days)”.

Further, from the production cost price information 216 shown in FIG. 20, since accumulated value of the production cost price in the previous process “PCA-04 (simple test)” is “7 (MY)”, the non-synchronization degree is integrated as “2 (days)×7 (M¥)=14 (day·M¥) “. Further, as for the production ID “CB-01”, since the non-synchronization degree is “0 (day·M¥)”, “14 (day·M¥)” is totally integrated.

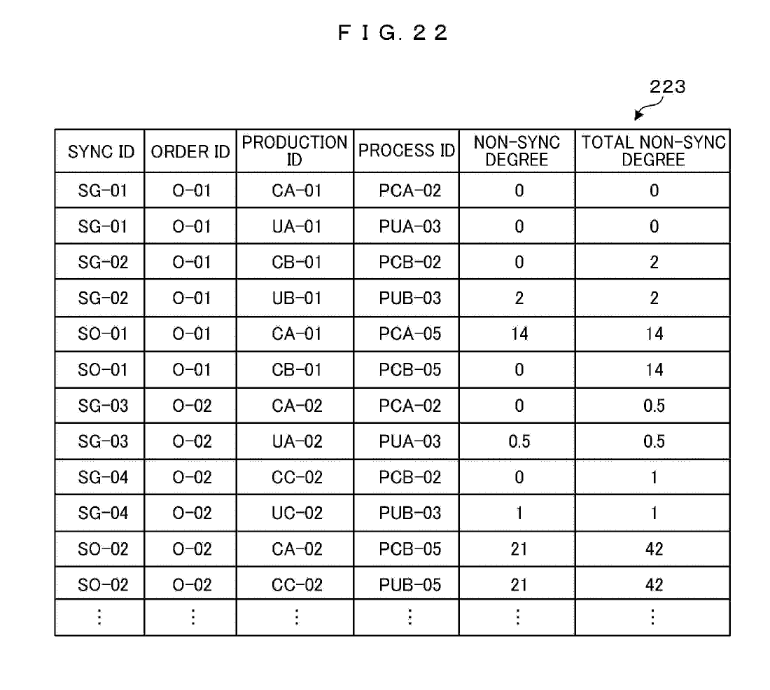

The non-synchronization degree calculation unit 326 collects the value every component of the product, the value being obtained by integrating accumulation of the product cost price during the period between each synchronization process and the previous process (S1745). In the present embodiment, supposed that the non-synchronization degree information 223 shown in FIG. 22 is produced from the non-synchronization degree every component integrated in the process of S1735, description will be done hereinafter.

Returning to the flowchart shown in FIG. 1, the display control unit 327 respectively stores the information of the production schedule plan every order item stored in the memory unit 310, the production load for the production resource every date, the non-synchronization degree integrated in S1735 into the production schedule plan information 221, the production load information 222 and the non-synchronization degree information 223 and displays on the input-output unit 100 (S180).

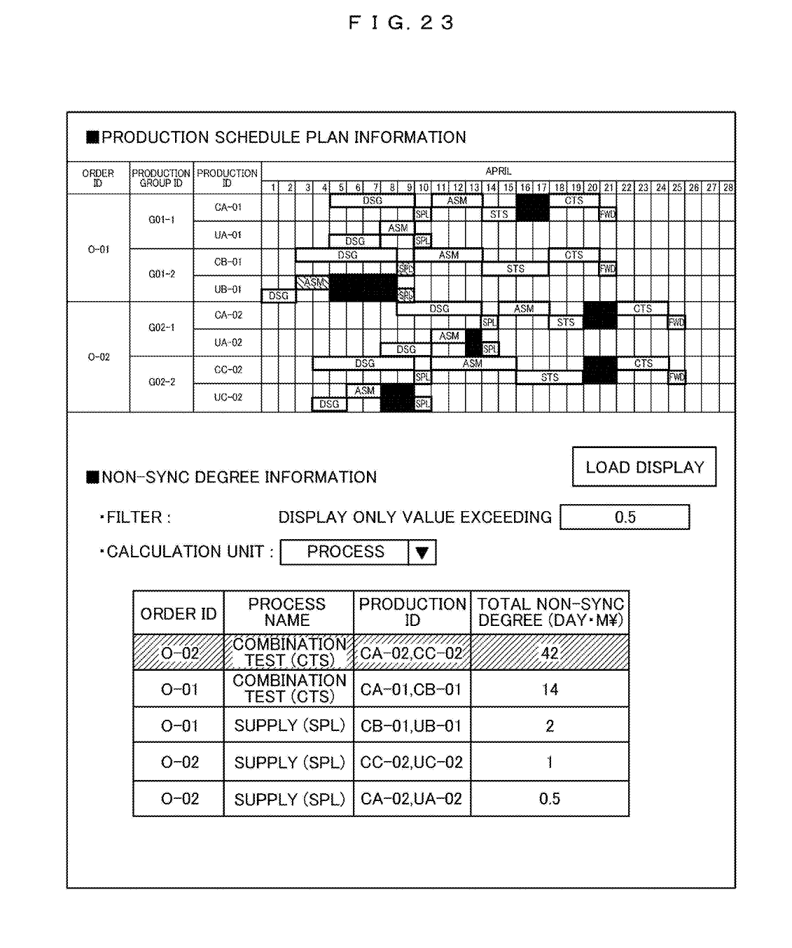

The output screen example in the present embodiment is indicated in FIG. 23. Although construction of the output screen is as same as that in the first embodiment, the total value of the non-synchronization degree is represented as “day M¥” and such value is obtained by integrating the period between the synchronization process and the previous process by the production cost price (sum). Based on the output screen, the user can grasp affects for inventory due to staying of middle work in hand, against the process in which production synchronization is not realized. Further, it can be shown the item considering plant management and the priority order of measures of processes.

In the present embodiment, although the accumulated value of the production cost price is utilized when the non-synchronization degree is appreciated (S1735), it may be utilized cost of the occupation area (area) of factory or place occurring due to staying of middle work in hand. Thereby, it can be made the priority order of measures considering stock cost against large product or unit in particular.

### Third Embodiment

As a third embodiment, against the process in which synchronization of production in a plurality of components is demanded, it is indicated an example that the other process in which the same production resource as the above process is consumed during some period is extracted and it is exchanged the order of the order item in which the above process is conducted.

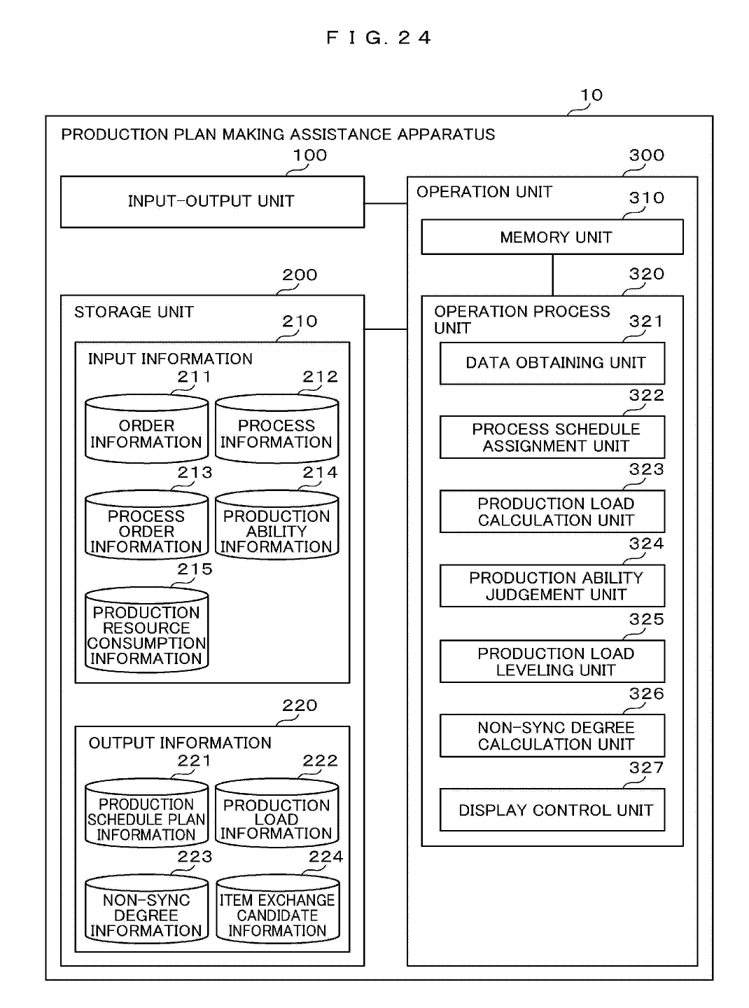

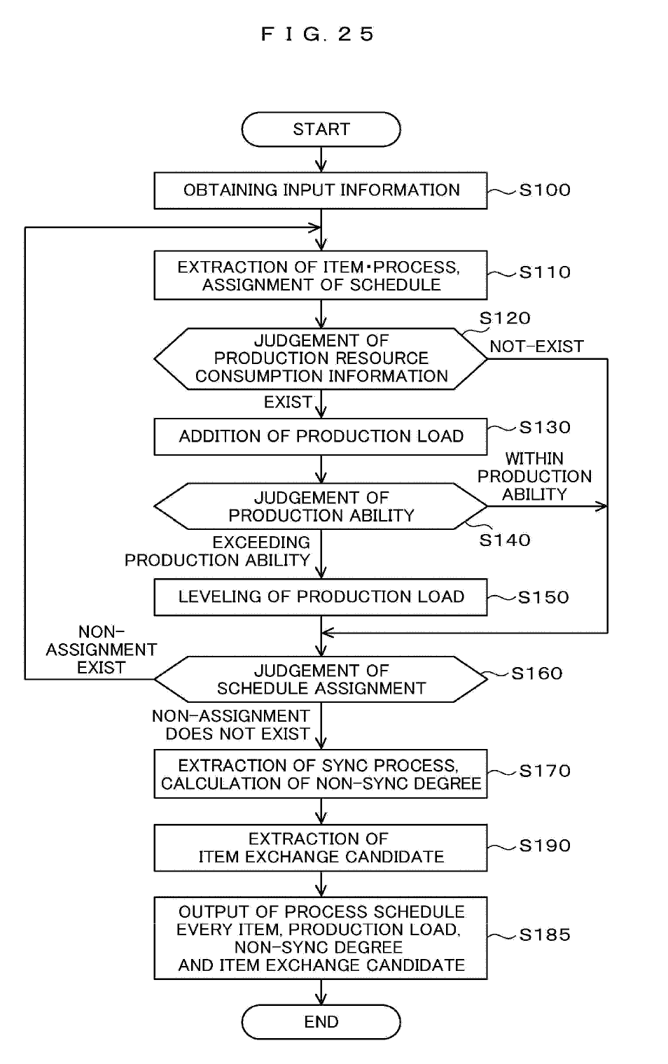

The production plan making assistance apparatus 10 of the present embodiment, as shown in FIG. 24, has construction in which item exchange candidate information 224 is added to the output information 220 of the storage unit 200 in the construction of the production plan making assistance apparatus 10 shown in FIG. 2 and item exchange candidate extraction unit 328 is added to the operation process unit 320 of the operation unit 300. Further, the processes of the present embodiment will be described by using the flowchart shown in FIG. 25 and description of the processes as same as those in the first embodiment will be omitted.

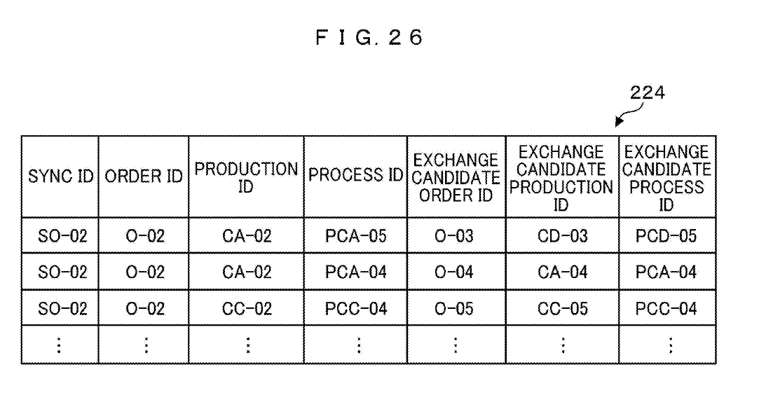

The item exchange candidate information 224 is information to control item candidate having room to improve the total non-synchronization degree by exchanging injection order of each synchronization process and the previous process. The item exchange candidate information 224 includes the information of the synchronization ID, the order ID, the production ID, the process ID, the exchange candidate order ID, the exchange candidate production ID, the exchange candidate process ID. In the item exchange candidate information 224 shown in FIG. 26, it is indicated that the order ID “O-03”, the production ID “CD-03”, the process ID “PCD-05 (combination test” exist as the exchange candidate of the order ID “O-02”, the production ID “CA-02”, the process ID “PCA-05 (combination test)” for the synchronization ID “SO-02”.

Next, according to the flowchart shown in FIG. 25, it will be described operation of each function in the production plan making assistance apparatus 10 in FIG. 24.

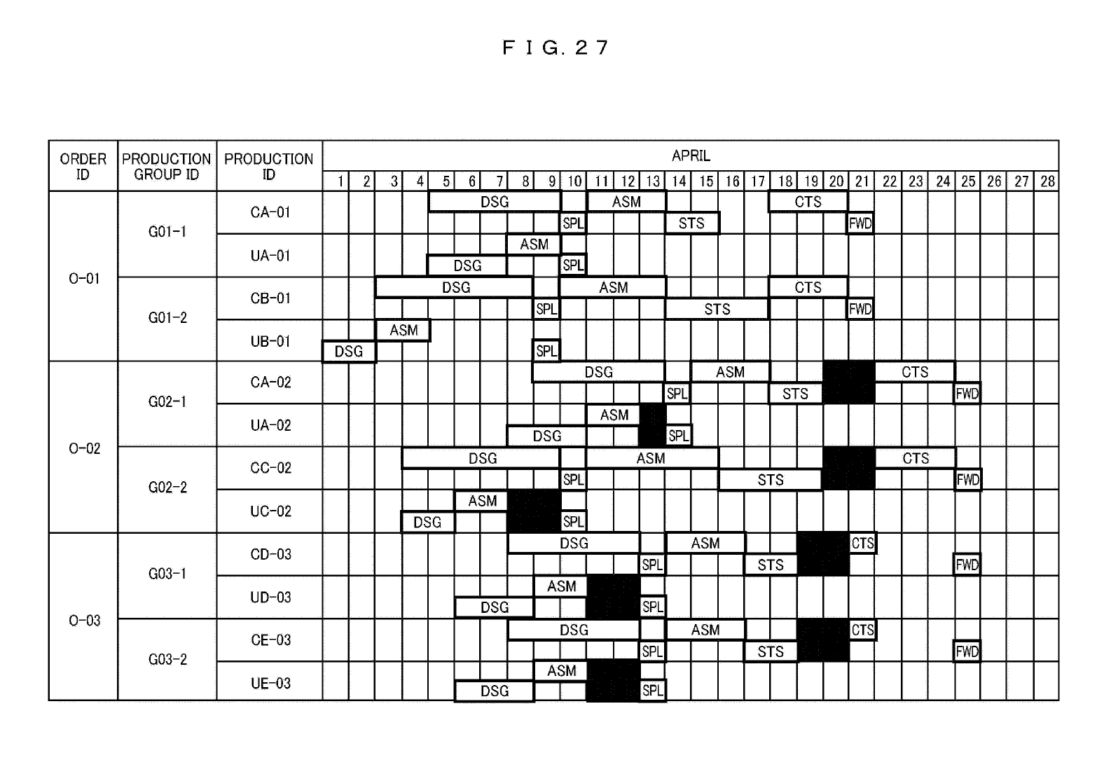

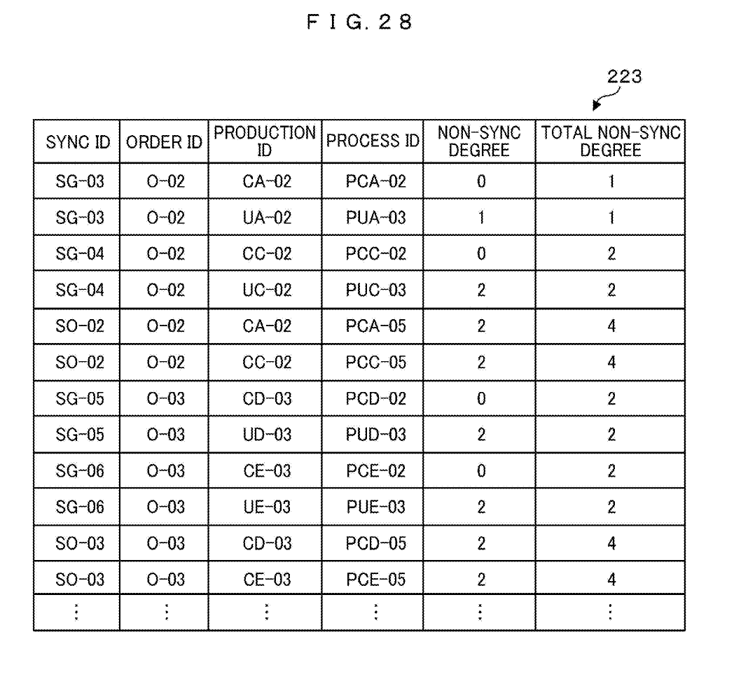

First, the data obtaining unit 321 obtains the order information 211, the process information 212, the process order information 213, the production ability information 214 and the production resource consumption information 215 (S100). Here, supposed that various kinds of information shown in FIGS. 3 to 7 are obtained, description will be done hereinafter. Processes in S110 to S170 are as same as those in the first embodiment, thus description thereof will be omitted. Further, supposed that the production schedule plan shown in FIG. 27 and the non-synchronization degree information 223 shown in FIG. 28 are produced, description will be done.

The item exchange candidate extracting unit 328 extracts the other order item and process having the common production resource against each synchronization process and the previous process (S190). For example, in the production schedule plan shown in FIG. 27, when the process “combination test of the order ID “O-03” shares the production resource “R-a (combination test area)” against the process “combination test) of the order ID “O-02”, it is extracted the information concerning the process (combination test) of the order ID “O-03”.

Further, as shown in the first record column of FIG. 26, the item exchange candidate extracting unit 328 attaches string to the exchange candidate order ID “O-03”, the exchange candidate production ID “CD-03”, the exchange candidate process ID “PCD-05” against the order ID “O-02”, the production ID “CA-02”, the process ID “PCA-05 (combination test)” concerning the synchronization process “SO-02” and produces the information of the item exchange candidate information 224.

The display control unit 327 respectively stores the information the production schedule plan stored in the memory unit 310 every order item, the production load for production resource every date, the non-synchronization degree and the information of the item exchange candidate within which string is attached into the production schedule plan information 221, the production load information 222, the non-synchronization degree information 223 and item exchange candidate information 224 and displays on the input-output unit 100 (S185).

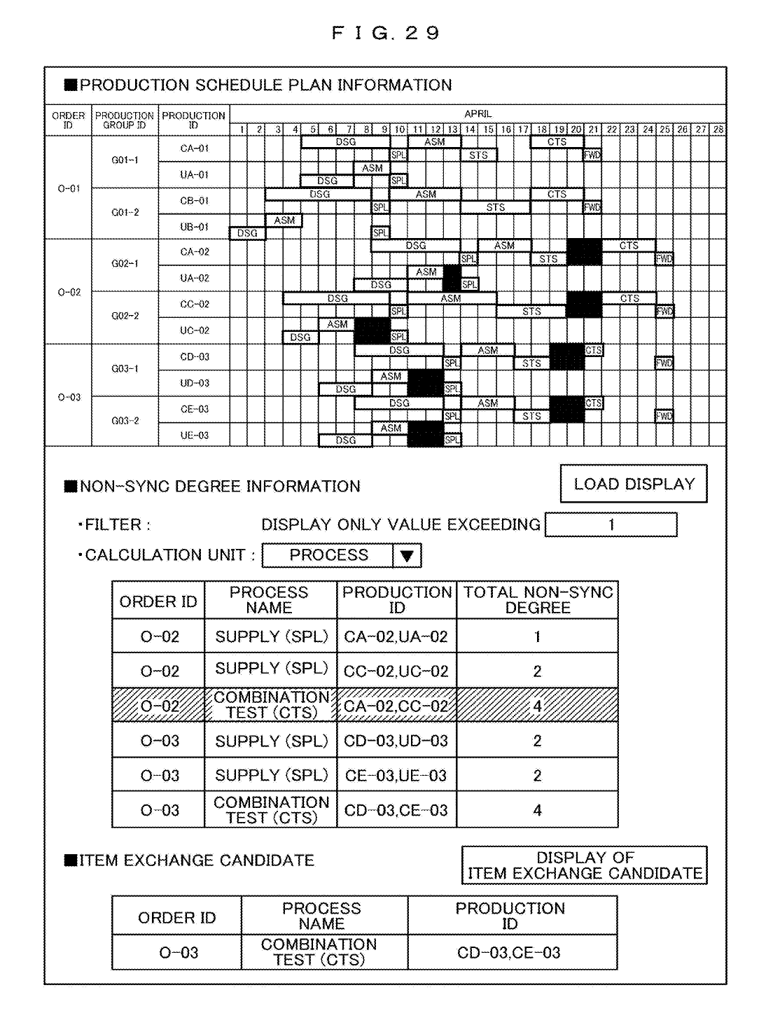

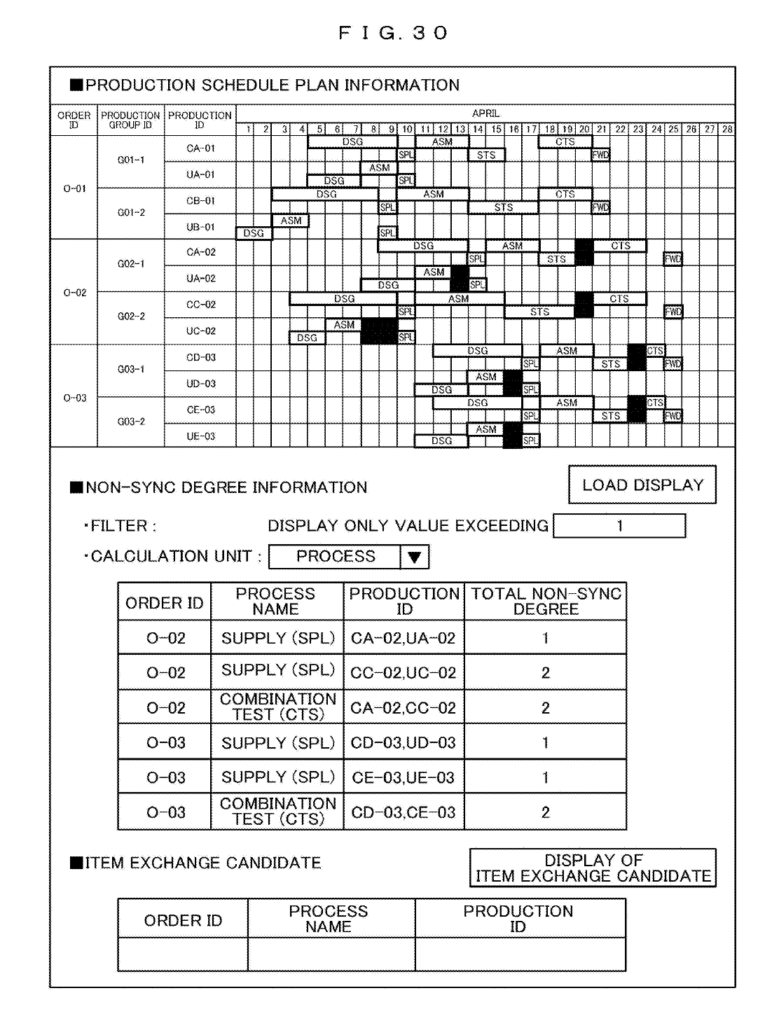

The output screen example of the present embodiment is shown in FIG. 29. In construction of the output screen, the “item exchange candidate display button” is added to the contents (FIG. 16) of the first embodiment. When the record of the table of the non-synchronization information in FIG. 29 is selected and the “item exchange candidate display button” is clicked, the information of the order ID, the process name and the process ID is displayed in the item exchange candidate column. Here, although the total of the non-synchronization degree is not sorted in big order so that comparison with FIG. 30 becomes easily understandable in FIG. 29, the total may be sorted.

Here, when injection order of “combination test” is exchanged to the order ID “O-03”, “O-02”, the output screen example is shown in FIG. 30. In the non-synchronization degree information shown in FIG. 30, the total of the non-synchronization degree is changed from “4” to “2” by exchanging the injection order of “combination test”. Thereby, the total of the non-synchronization degree of the order ID O-03”, the process (combination test) is improved from “4” to “2”.

Further, comparing the production schedule plan information column in FIG. 29 with that in FIG. 30, the lead time of the order ID “O-03” is shortened from 20 days (4/6 to 4/25) to 15 days (4/11 to 4/25) while not changing the lead time of the order ID “O-02” (days from design to forwarding).

As described in the above, the information concerning the other order item consuming the same production resource can be displayed as the item exchange candidate. Based on this display, the user can effectively carry out the production schedule exchange to reduce middle work in hand or to realize shortening of the lead time against the process in which the synchronization of production cannot be done.

What is claimed is:

1. A production plan making assistance apparatus for a product including a plurality of components, the production plan making assistance apparatus comprising:
a storage unit for storing information of lead time in each process of a plurality of processes to produce each component, information of the process synchronizing in production of different component, information of production ability of production resource and information of production resource consumption in each process;
an input-output unit for displaying a process result; and
an operation unit for processing the information stored in the storage unit;
wherein the operation unit reads out the information stored in the storage unit and assigns a start date and a completion date in each process based on a process in which consumption of the production resource lies within the production ability and which synchronizes with the lead time, and
wherein the operation unit specifies the completion date assigned to each previous process in a plurality of synchronizing processes, specifies a start date assigned to the process continuing to the specified completion date, calculates a total period between the specified completion date and the specified start date as a total non-synchronization degree and outputs the calculated total non-synchronization degree to the input-output unit.

2. The production plan making assistance apparatus according to claim 1,
wherein the input-output unit displays names of a plurality of processes which synchronize and the calculated total non-synchronization degree while corresponding the names and the total non-synchronization degree.

3. The production plan making assistance apparatus according to claim 2,
wherein the input-output unit further displays information of the start date and the completion date of the process for producing the product and a process table including information of date utilized for calculation of the total non-synchronization degree.

4. The production plan making assistance apparatus according to claim 3,
wherein the input-output unit further displays a state of consumption of production resource occupying in the production ability.

5. The production plan making assistance apparatus according to claim 1,
wherein the input-output unit receives information concerning a product and an order, and
wherein the input-output unit further adds up every order unit that the calculated total non-synchronization degree is received and displays the non-synchronization degree corresponding to the received order

6. The production plan making assistance apparatus according to claim 1,
wherein the operation unit specifies a second completion date assigned to a second process previous to a first process among a plurality processes which synchronize, specifies a first start date assigned to the first process and calculates a period between the second completion data and the first start date as a first non-synchronization degree,
wherein the operation unit specifies a fourth completion date assigned to a fourth process previous to a third process among a plurality processes which synchronize, specifies a third start date assigned to the third process and calculates a period between the fourth completion data and the third start date as a third non-synchronization degree, and
wherein the operation unit calculates a total of the first non-synchronization degree and the third non-synchronization degree as a total non-synchronization degree.

7. The production plan making assistance apparatus according to claim 1,
wherein the operation unit operates as:
a process schedule assignment unit assigning the start date and the completion date in each process based on the process which synchronizes with the lead time;
a process load calculation unit for adding consumption of the production resource till the assigned completion date from the assigned start date;
a process ability judgement unit for comparing the added consumption with the production ability and for judging whether or not the added consumption exceeds the production ability;
a production load leveling unit for shifting the assigned start date and the completion date when judged that the added consumption exceeds the production ability;
a non-synchronization degree calculation unit for specifying the completion date assigned to the previous process in each of a plurality processed which synchronize, for specifying the start date assigned to the process continuing to the specified completion date and for calculating a total period between the specified completion date and the specified start date as the total non-synchronization degree; and
a display control unit for outputting the calculated total non-synchronization degree to the input-output unit.

8. The production plan making assistance apparatus according to claim 1,
wherein the storage unit further stores information of production cost price till each process from a first process,
wherein the operation unit specifies the completion date assigned to the previous process in each of a plurality processed which synchronize, specifies the start date assigned to the process continuing to the specified completion date and multiplies a period between the specified completion date and the specified start date by the production cost price up to the previous process and calculates a total of multiplied result as the total non-synchronization degree and outputs the calculated non-synchronization degree to the input-output unit.

9. The production plan making assistance apparatus according to claim 8,
wherein the input-output unit displays names of a plurality of processes which synchronize and the calculated total non-synchronization degree while corresponding the names and the total non-synchronization degree.

10. The production plan making assistance apparatus according to claim 1,
wherein the input-output unit receives information concerning a plurality of products and orders,
wherein the operation unit assigns the start date and the completion date in each process based on a process in which consumption of the production resource lies within the production ability every received order and which synchronize with the lead time,
wherein the operation unit specifies the completion date assigned to the previous process in each of a plurality of processes which synchronize, specifies the start date assigned to the process continuing to the specified completion date and calculates a total period between the specified completion date and the specified start date as the total non-synchronization degree,
wherein the operation unit outputs to the input-output unit information of the total non-synchronization degree calculated for a first order and a synchronizing process for a second order when a synchronizing process for the first order among a plurality of received processes and a synchronizing process for the second order among a plurality of received orders shares same production resource.

11. The production plan making assistance apparatus according to claim 10,
wherein the input-output unit displays names of a plurality of synchronizing processes for the first order and the calculated total non-synchronization degree while corresponding the names and the total non-synchronization degree and displays information of a synchronizing process for the second order as an item exchange candidate.

12. The production plan making assistance apparatus according to claim 11,
wherein the input-output unit receives instruction of item exchange, and
wherein the operation unit assigns the start date and the completion date to each process against the first order after assigning the start date and the completion date to each process against the second order.

13. A production plan making assistance method for a product including a plurality of components,
a computer stores information of lead time in each process of a plurality of processes to produce each component, information of the process synchronizing in production of different component, information of production ability of production resource and information of consumption of the production resource in each process,
wherein the computer reads out the stored information, assigns a start date and a completion data to each process based on a process in which consumption of the production resource lies within the production ability and which synchronizes with the lead time, specifies a completion date assigned to each previous process among a plurality of synchronizing processes, specifies a start date assigned to the process continuing to the specified completion date, calculates a total period between the specified completion date and the specified start date as a total non-synchronization degree and outputs the calculated total non-synchronization degree to the input-output unit.

14. The production plan making assistance method according to claim 13,
wherein names of a plurality of processes which synchronize and the calculated total non-synchronization degree are displayed while corresponding the names and the total non-synchronization degree.

15. The production plan making assistance method according to claim 14,
wherein information of the start date and the completion date of the process for producing the product and a process table including information of date utilized for calculation of the total non-synchronization degree are displayed.
